(19) United States
(12) Patent Application Publication
(10) Pub. No.: US 2016/0210669 A1
(43) Pub. Date: Jul. 21, 2016

(54) ON-SITE SALES AND COMMERCIAL SEARCH METHOD AND SYSTEM

(71) Applicants: Alfred Xueliang Xin, Cincinnati, OH (US); Sherry Xiaoli Sun, Cincinnati, OH (US)

(72) Inventors: Alfred Xueliang Xin, Cincinnati, OH (US); Sherry Xiaoli Sun, Cincinnati, OH (US)

(21) Appl. No.: 14/599,459

(22) Filed: Jan. 17, 2015

(51) Int. Cl. G06Q 30/02; H04W 4/02; H04W 8/00

(52) U.S. Cl. CPC G06Q 30/0261; G06Q 30/0267; H04W 8/005; H04W 4/02

(57) ABSTRACT

An automated on-site sales and commercial search method and system reaches out to a shopper with sales and commercial information when the shopper is in, at or visibly close to a business. A software application installed on a mobile device such as cellphone with internet connection and web map such as google map or GPS to locate physical location of a shopper. The software communicates with its hosting web server, and the hosting server verifies location of the mobile device and sends and displays commercials on a map or a floor layout on screen of the mobile device. When commercials are available the system get user's attention by playing audio and or visual signals. Detailed commercial is either announced through a speaker, or directly showing on a popup window with static information or video clip. Shopper may also select to make a phone call even before get into the premises of a business.

### BACKGROUND OF INVENTION

Shoppers go to the store and looking for good deals, or bring in sales coupons for shopping, and very likely they won't be able to get all the sales information, and further there is no way they may be able to get sales' information for all shops onsite based on accurate locations of the stores in the area. Therefore there is a need to invent an on-site sales and commercial search method and system. A software application of said system may be installed on mobile electronic devices such as cellphone, and it may utilize web map such as google map or GPS to locate the physical location of shoppers and automatically retrieve information for best deals for shoppers in, at or visibly close to said shops.

The software application communicates with its hosting web server, and the hosting server verifies location of the mobile device and sends and displays commercials on a map or a floor layout on screen of the mobile device. When commercials are available the system gives user audio and or visual signals and displays detailed commercial directly showing on a popup window with either static information, voice announcement or video clip. Shopper may also select to make a phone call even before get into the premises of a business.

### FIELD OF THE INVNETION

The present invention generally relates to automatically search for shopping and products sales and promotional coupons in, at or visibly close shoppers through internet geographical map search and website products sales and promotional postings, and proactively reaches out to users with mobile device installed with the software application. Such method and system shall actively remind shoppers and provide then with clear choices on what are the best deals when they are in front of a store(s) location and or floor layouts on an onsite map.

### SUMMARY OF THE INVENTION

An on-site sales and commercial search method and system comprise of a software application installed or displayed on a web browser on a mobile electronic device, such as cellphone, is coupled to and capable of receiving geographical locations information through digital map such as Google map or GPS and internet connection.

Within a shopping area shoppers with said mobile device Said shoppers may be able to obtain all sales and new products information in different stores in, at or visibly close to them; said shoppers may decide which store they would like to go shopping with clear choices and best deals according visualized store locations and or floor layouts on an onsite map.

The automated command and popup functions may notify shoppers with a ringtone to get detailed information on commercials right in front of them, and directly showing on a popup window with static information, voice announcement or video clip. Shoppers may also select to make a phone call even before get into the premises of a business.

Instead of passively waiting for buyers to find business with good deals and sales' commercials like websites and current coupon searching programs do, said system actively reaches out to potential customers in, at or close to a business location and provide business with means of live commercials right in, at or close to its door. Said system acts like having an employee standing in, at or near a business and telling all import deals and high-lighted information to potential buyers or customers.

### BRIEF DESCRIPTION OF DRAWINGS

FIG. 1-A is flow chart that demonstrates logical flows of an on-site sales and commercial search method and system between onsite shoppers and a website with sales' commercials and coupons.

FIG. 2-A shows a home screen of a cellphone with “Shopping Deals” button. FIG. 2-B shows first screen of said on-site sales and commercial search method and system with its market name. FIG. 2-C shows a flow map of mall displayed after a user selects “All Stores” button. FIG. 2-D shows deals from a store after said user selects a store from said map. FIG. 2-E shows deals with stores selling shoes within the mall.

FIG. 3-A shows a home screen of a cellphone with “Shopping Deals” button. FIG. 3-B shows first screen of said on-site sales and commercial search method and system with its market name. FIG. 3-C shows a street map with store and business layouts after user selected “All Stores” button. FIG. 3-D shows deals from a store after said user selects a store from said street map. FIG. 3-E shows deals with stores selling shoes from stores displayed on said street map near said user.

FIG. 4-A shows a home screen of a cellphone with “Shopping Deals” button. FIG. 4-B shows deals in a department store as user is in said department store. FIG. 4-C shows an advertisement shown in a popup window as a user activated popup feature for showing onsite deals within a very close range. FIG. 4-D shows customer comments posted online about a business.

FIG. 5-A shows a video clip recorded by a business played in a popup window as a user activated popup feature for showing onsite deals within a visible range of said business.

### PREFFERED EMBODIMENT

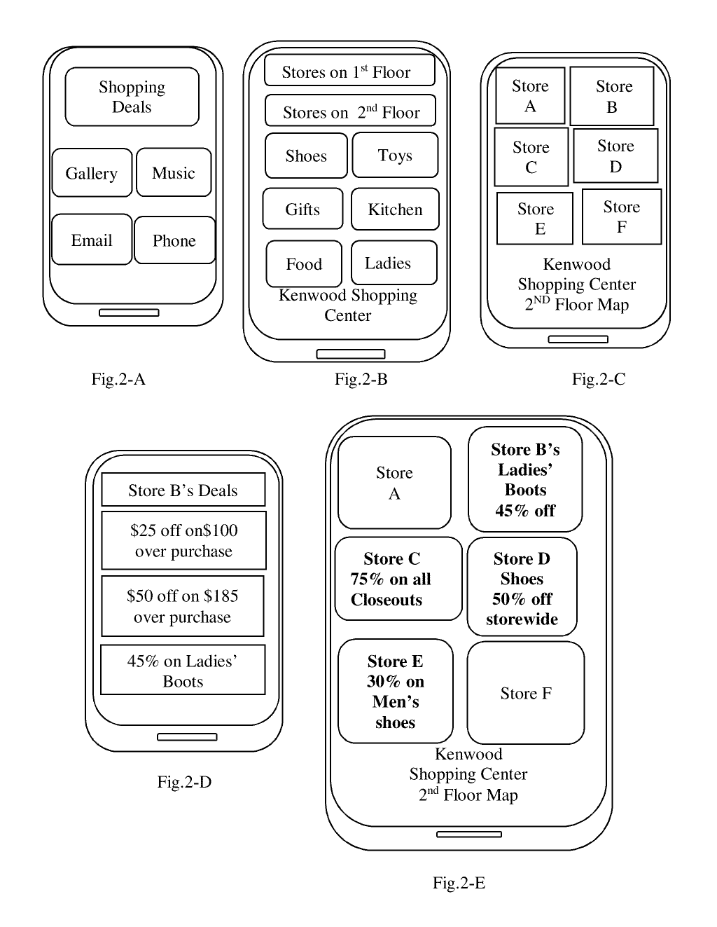

Referencing to drawings in Fig.-A, a preferred embodiment of said on-site sales and commercial search method and system. A shopper is in a shopping mall area and has a cellphone installed with an on-site sales and commercial search software displayed as “Shopping Deals” and connected to internet and google map. Said shopper selects “Shopping Deals” button (FIG. 2-A) on his cellphone and then selects “All Stores” button (FIG 2-B) in an attempt to get sales' information and discount coupons in the entire shopping mall area. Said software on said cellphone then sends a request on searching sales deals for the entire shopping mall area within said shopping mall to a website(s).

Said cellphone receives all sales information from all the stores in said shopping mall from said hosting web server and displays all the stores heighted that have sales offers (FIG. 2-C) on a floor map on the screen of said cellphone.

Said shopper requests sales information from a store by touching said store's location and name on said floor map and the request is sent back to said hosting web server. Said hosting web server sends back entire available sales discounts offers posted by said store back to said cellphone and displays said commercial images on its screen (FIG. 2-D).

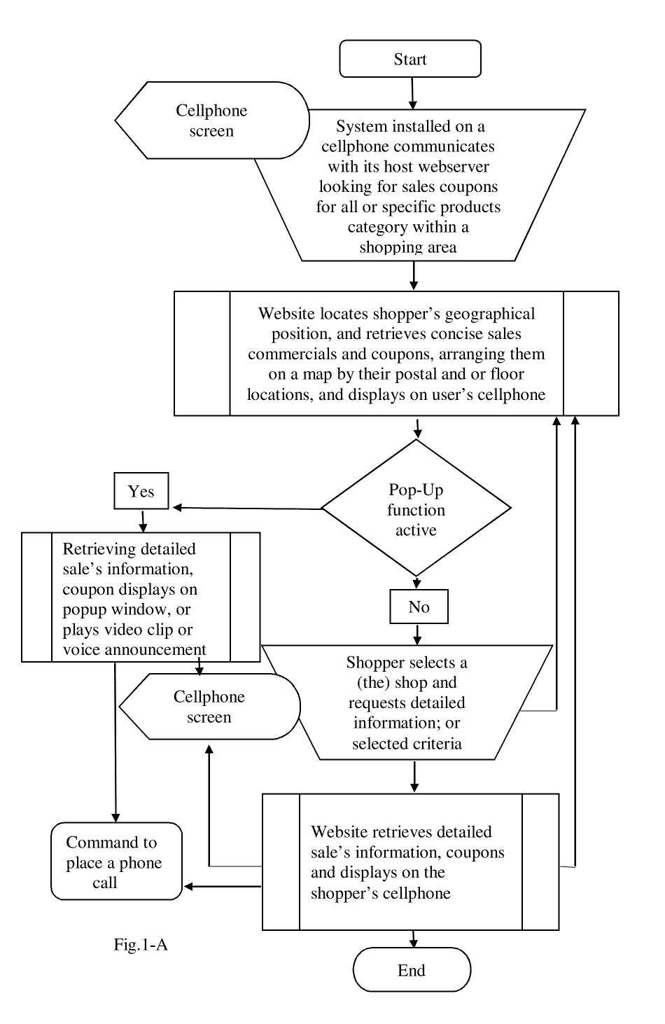

Referencing to drawings in FIG. 1 of another preferred embodiment of said on-site sales and commercial search method and system displayed on a cellphone as “Shopping Deals”. A shopper is in a shopping mall area and has a cellphone connected to internet and google map. Said shopper selects “Shopping Deals” button (FIG. 2-A) on his cellphone and then selects “Shoes” button (FIG. 2-B) selecting to get sales' information and discount coupons for a particular merchandise category. Said cellphone then sends a request to on searching sales deals for the entire shopping area within said shopping mall to website(s).

Said sales information on said merchandise category from all stores with said merchandise in said shopping mall are sent back by hosting web server with all sales offers by said stores to said cellphone and displayed on said cellphone with commercial images on its screen (FIG. 2-E).

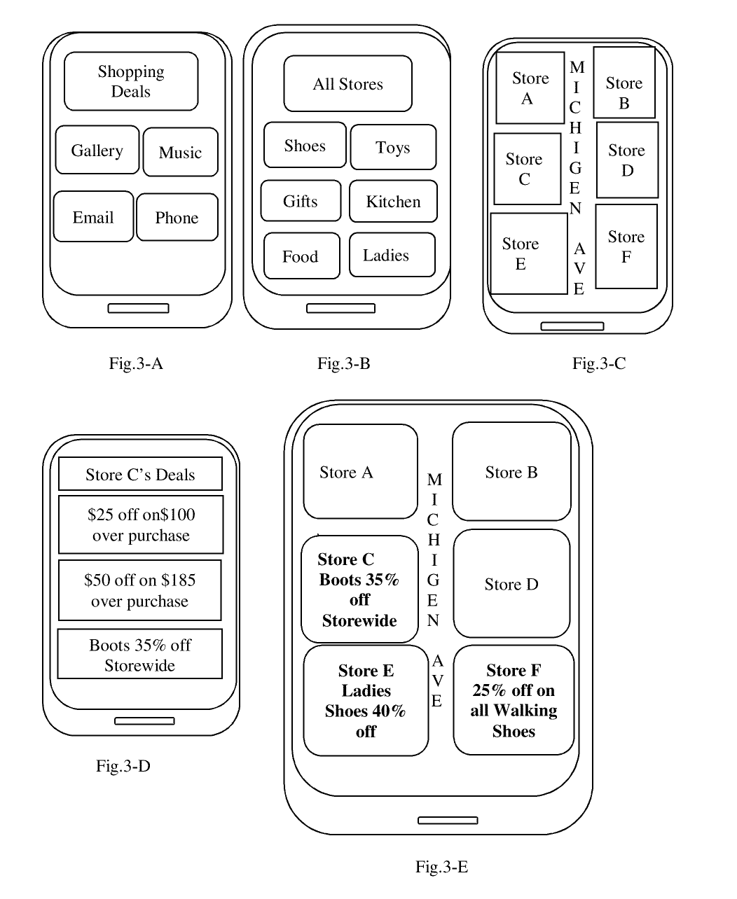

Referencing to drawings in FIG. 1 of still another preferred embodiment of said on-site sales and commercial search method and system displayed as “Shopping Deals” on a cellphone screen. A shopper is in a shopping street area with said cellphone connected to internet and google map. Said shopper selects “Shopping Deals” button (FIG. 3-A) on his cellphone and then selects “All Stores” button (FIG. 3-B) trying to get sales' information and discount coupons from stores within a range of said shopping area. Said cellphone then sends a request said hosting web server on searching sales deals for all stores within a range of said shopper.

Said mobile device receives all sales information from all the stores in a range of said shopper's physical position and displays an area map with all the stores heighted that have sales offers (FIG. 3-C) on its screen.

Said shopper requests sales information from a store by touching said store's location on said onsite map and the request is forwarded to said hosting web server, said mobile device receives entire available sales discounts offers posted by said store from said hosting website, and displays said commercial images on its screen (FIG. 3-D).

Referencing to drawings in FIG. 1 of still another preferred embodiment of said on-site sales and commercial search method and system. A shopper is in a shopping street area and has a cellphone connected to internet and google map. Said shopper selects “Shopping Deals” button (FIG. 3-A) on his cellphone and then selects “Shoes” button (FIG. 3-B) selecting to get sales' information and discount coupons for a particular merchandise category. Said cellphone then sends a request on searching sales deals for the entire shopping area within a range of said shoppers' physical position to website(s).

Said mobile device receives all sales information on said merchandise category from all stores with said merchandise in said shopping street area and displays lists all sales offers with said commercial images on its screen (FIG. 3-E).

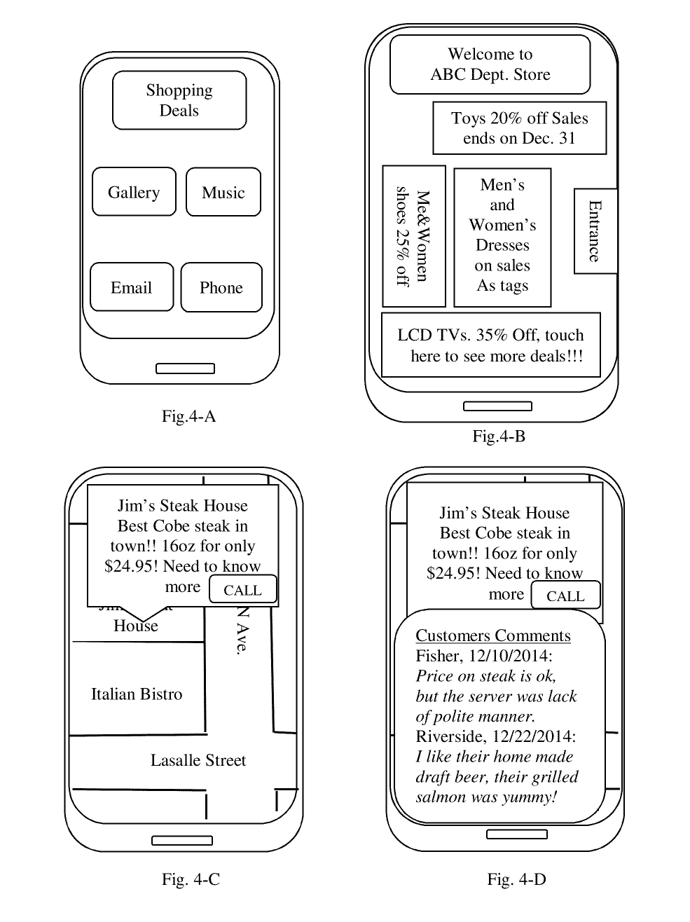

Referencing to drawings in FIG. 1 of still another preferred embodiment of said on-site sales and commercial search method and system displayed on a cellphone as “Shopping Deals”. A shopper is in a department store and has said cellphone connected to internet and google map. Said shopper selects “Shopping Deals” button (FIG. 4-A) on his cellphone. Said hosting web server detects that said shopper is in a single unit commercial building at a postal address, and said hosting web server then sends back commercials arranged by departments to said cellphone.

Said cellphone receives all sales information on said department store and displays said commercial images on its screen (FIG. 4-B).

Referencing to drawings in FIG. 1 of still another preferred embodiment of said on-site sales and commercial search method and system displayed on a cellphone as “Shopping Deals”. A shopper has pre-activated oral-command entering_feature, and auto report and announcement feature for close-range deals. Said shopper gives oral-command through a micro-phone installed on said cellphone and looking for a dining-in restaurant. As said shopper walk through in front of a restaurant, said system measures said shopper is within 50 feet of said restaurant (a range is pre-setup by said restaurant to activate its commercial) and remains within the range for at least 10 seconds (such validation is applied to make sure that said shopper stays near the premises), a special ring tong is played as to get attention from said shopper and also a commercial from said restaurant is announced through a speaker installed on said cellphone, and or a popup window with said commercial from said restaurant is also displayed on said screen of said cellphone (FIG. 4-C), Said shopper gives oral-command and looking for comments from said restaurant's customers and said system searches websites and displays most recent comments on said cellphone screen (FIG. 4-D).

Said shopper gets everything he wants to know about said restaurant without having to get into the restaurant. As said shopper walks away from said restaurant, said system measures_said shopper is beyond 20 feet range from said restaurant for more than 5 second, and said popup widow automatically disappeared from said cellphone screen (FIG. 4-B).

Referencing to drawings in FIG. 1 of still another preferred embodiment of said on-site sales and commercial search method and system displayed on a cellphone as “Shopping Deals”. A shopper has pre-activated oral-command entering feature, and auto report and announcement features for close-range deals. Said shopper gives oral-command through a micro-phone installed on said cellphone and looking for a dining-in restaurant.

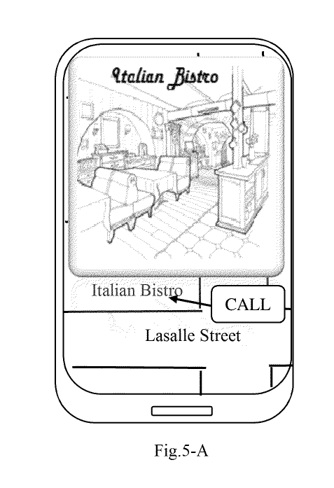

As said shopper walk through in front of a restaurant, said cellphone receives a uniquely assigned digital code to said restaurant sent out by a signal emitter installed within premises of said restaurant. Said system receives said digital code and sent back to its hosting web server, said hosting server retrieves commercials and sent back to said cellphone. A special ring tong is played as to get attention from said shopper. A video clip pre-recorded by said restaurant and uploaded to hosting web server played on a popup window with introduction of said restaurant and high-lighted dishes (FIG. 5-A). Said shopper gives an oral command and making a direct phone call to said restaurant for more information.

The embodiments are mainly illustrations on the invention, advantages of the invention will be set forth in part in the description which follows, and in part will be obvious from the description, or may be learned by practice of the invention. The advantages of the invention will be realized and attained by means of the elements and combinations particularly pointed out in the claims. Further it is to be understood that both the foregoing general descriptions and detailed descriptions are exemplary and explanatory only and are not limited to the invention as claimed.

1. An on-site sales and commercial search method and system comprising:
a. a software application installed on a mobile device such as a cellphone coupled to internet connection and a web-map such as google map or GPS (Global Position System);
b. a hosting webserver is capable of communicating with said software application and automatically updating location of said software application and forwarding commercial with a business at location of said mobile device installed with software application;
c. said software application installed on said mobile device is capable of communicating with said hosting webserver and automatically receiving and updating commercial and sales information posted by a business when a user with said mobile device is in, at or visibly close to said business;
d. said mobile device is capable of automatically displaying and updating said commercial and sales information on a business-layout map according to its actual street location, and or actual floor layout of a business when a user of said mobile device is in, at or visibly close to said business.

2. The on-site sales and commercial search method and system of claim 1 wherein said software application on said mobile device coupled with said web-map is capable of updating and sending accurate physical location of said mobile device to said hosting webserver.

3. The on-site sales and commercial search method and system of claim 1 wherein said software application on said mobile device coupled to graphic user interface is capable of submitting various requests by user on new products and sales information posted online by business and shops within a visible range, postal address and or at location of said mobile device; and displays requested information sent back by said hosting webserver according to a business-layout map according to their actual street locations and or actual floor layouts within a radius range of said mobile device.

4. The on-site sales and commercial search method and system of claim 1 wherein said software application on said mobile device may be deployed on a web browser installed to said mobile device.

5. The on-site sales and commercial search method and system of claim 1 wherein said software application on said mobile device is capable of displaying floor layouts within structures of a building at a postal address.

6. The on-site sales and commercial search method and system of claim 1 wherein said hosting webserver is capable of submitting requests to multiple internet websites and optimizing searching results for further process.

7. The on-site sales and commercial search method and system of claim 1 wherein said system is capable of accepting oral commands from said user via a microphone installed on said mobile device.

8. The on-site sales and commercial search method and system of claim 1 wherein said software application is capable of displaying a selected business commercial on popup windows on screen of said mobile device when said user in, at or visibly close to said business.

9. The on-site sales and commercial search method and system of claim 8 wherein said software application is capable of receiving an uniquely assigned digital code to a business; said uniquely assigned digital code is sent out by a signal emitter located within premises of said business; said software application sends said uniquely assigned digital code to its host webserver, said host webserver search commercials posted and stored in its database by said business and sends back said commercials to said software application.

10. The on-site sales and commercial search method and system of claim 8 wherein said software application is capable of playing a special sound, ringtone or music to get attention from said user.

11. The on-site sales and commercial search method and system of claim 8 wherein said system is capable of making said popup window disappeared from screen of said mobile device when said user walks away and or leaves said business from a visibly close range, and or said assigned digital code signal weakened and replaced by another stronger assigned digital code for another business.

12.The on-site sales and commercial search method and system of claim 8 wherein said system is capable of announcing said selected commercial via a speaker installed on said mobile device.

13. The on-site sales and commercial search method and system of claim 8 wherein said software application is capable of searching and selecting and displaying comments on selected business posted on websites on screen of said mobile device.

14. The on-site sales and commercial search method and system of claim 8 wherein said software application is capable of playing recorded video clips with commercial of a business.

15. The on-site sales and commercial search method and system of claim 8 wherein said software application is capable of allowing user to make a phone call to said business via a touch button displayed on screen of said mobile device, or via oral command.

16. The on-site sales and commercial search method and system of claim 1 wherein said software application is capable of communicating with preconfigured webserver only.

17. The on-site sales and commercial search method and system of claim 8 Wherein said software system is capable of allowing said business to setup a defined physical range from its location to allow its commercial to be activated and get attention from a user with said mobile device installed with said software application, further activate popup windows and display its commercial.

18-19. (canceled)

18. The on-site sales and commercial search method and system of claim 8 Wherein said software system is capable of playing audio announcement or video clip Simultaneously, before and or after displaying detailed commercial information on a web page.

19. The on-site sales and commercial search method and system of claim 8 Wherein said software system is capable of replacing and or switching between web Pages, audio announcement and video clip recordings according to different sales and commercial requirements.

20. An on-site sales and commercial search method and system comprising steps with functions of: a software application coupled with a digital map such as google map or GPS and internet connection installed on a mobile device such as cellphone is capable of communicating with a hosting webserver;
said hosting webserver is capable of communicating with said software application and automatically updating location of said software application installed on said mobile device and sending commercial with business at location of said mobile;
said commercial information on a business-layout map according to their actual street location and or actual floor layouts when user with said mobile device installed with said software system is in, at or visibly close to said business;
said hosting webserver is capable of submitting requests to multiple internet websites and optimizing searching results for further process;
said system is capable of accepting oral commands from said user via a microphone installed on said mobile device;
said software application is capable of displaying selected business commercial by said user on popup windows on screen of said mobile device when said user is in, at or visible close to said business; said software application is also capable of showing recorded video clips with commercial of said business on said popup window;
said system is capable of making said popup window disappeared from screen of said mobile device when said user walks away and or leaves said business from a visibly close range;
said software application is capable of playing a special sound, ringtone or music to get attention from said user when said selected business commercial displayed on popup windows;
said software application is capable of receiving an uniquely assigned digital code to a business; said uniquely assigned digital code is sent out by a signal emitter located within premises of said business; said software application sends said uniquely assigned digital code to its host webserver, said host webserver search commercials from said business from its database and sends back to said software application;
said system is capable of announcing said selected commercial via a speaker installed on said mobile device;
said software application is capable of searching and selecting and displaying comments on selected business posted on websites on screen of said mobile device;
said software application is capable of allowing user to make a phone call to said business via a touch button displayed on screen of said mobile device, or via oral command.
